(19) United States
(12) Patent Application Publication
(10) Pub. No.: US 2001/0034842 A1
(43) Pub. Date: Oct. 25, 2001

(54) Common network security

(76) Inventors: Matthew Kochumalayil Chacko, San Francisco, CA (US); Jeffrey Taihana Tuatini, San Francisco, CA (US)

Correspondence Address: PERKINS COIE LLP, PATENT-SEA, P.O. BOX 1247, SEATTLE, WA, 98111-1247, US

(21) Appl. No.: 09/745,073

(22) Filed: Dec. 19, 2000

Related U.S. Application Data
(60) Provisional application No. 60/173,943, filed on Dec. 30, 1999.

(51) Int. Cl. H04L 9/32; H04L 12/22

(52) U.S. Cl. 713/201; 713/153; 709/229

(57) ABSTRACT

A method and system for providing network security for Internet, intranet, and extranet networks using a common mechanism. The common network security system provides a common security mechanism for use when communicating via the Internet, intranet, or extranet. The common network security system provides a security module that can be shared by a web server that services the Internet and a web server that services an intranet. The Internet web server is shielded from the Internet via a site firewall and the security module is shielded from the Internet web server via a security firewall. The intranet web server is connected directly to the security module.

### CROSS-REFERENCE TO RELATED APPLICATION

This application claims the benefit of U.S. Provisional Patent Application No. 60/173,943, entitled “COMMON NETWORK SECURITY,” filed on Dec. 30, 1999 which is incorporated herein by reference.

### TECHNICAL FIELD

The described technology relates to security for computer systems.

### BACKGROUND

Today's computer networking environments, such as the Internet, offer mechanisms for delivering documents between heterogeneous computer systems. One such network, the World Wide Web network, which comprises a subset of Internet sites, supports a standard protocol for requesting and receiving documents known as web pages. This protocol is known as the Hypertext Transfer Protocol, or “HTTP.” HTTP defines a high-level message passing protocol for sending and receiving packets of information between diverse applications. Details of HTTP can be found in various documents including T. Berners-Lee et al., Hypertext Transfer Protocol—HTTP 1.0, Request for Comments (RFC) 1945, MIT/LCS, May 1996. Each HTTP message follows a specific layout, which includes among other information, a header which contains information specific to the request or response. Further, each HTTP request message contains a universal resource identifier (a “URI”), which specifies to which network resource the request is to be applied. A URI is either a Uniform Resource Locator (“URL”) or Uniform Resource Name (“URN”), or any other formatted string that identifies a network resource. The URI contained in a request message, in effect, identifies the destination machine for a message. URLs, as an example of URIs, are discussed in detail in T. Berners-Lee, et al., Uniform Resource Locators (URL), RVC 1738, CERN, Xerox PARC, Univ. of Minn., Dec. 1994.

The World Wide Web is especially conducive to conducting electronic commerce (“e-commerce”). E-commerce generally refers to commercial transactions that are at least partially conducted using the World Wide Web. For example, numerous web sites are available through which a user using a web browser can purchase items, such as books, groceries, and software. A user of these web sites can browse through an electronic catalog of available items to select the items to be purchased. To purchase the items, a user typically adds the items to an electronic shopping cart and then electronically pays for the items that are in the shopping cart. The purchased items can then be delivered to the user via conventional distribution channels (e.g., an overnight courier) or via electronic delivery when, for example, software is being purchased. Such web sites are referred to as business-to-consumer (“B2C”) web sites because the commercial transaction is typically between a company and an individual who is the consumer.

Many traditional companies have found it particularly useful to allow their business customers to have access to application programs that the companies use internally. For example, a company that designs and sells equipment for use in factories may have developed application programs to assist the company in selecting the equipment that meets the requirements of their customers. Although these application programs may have been used internally for quite some time, the companies can help attract new customers and retain existing customers by making such application programs available for use by their customers. The companies may develop web sites through which their business customers can access these applications. Such web sites are referred to a business-to-business (“B2B”) web sites.

One recurring problem with making these application programs available to customers is security. The companies need to ensure that the data of their customers is not compromised and that only authorized customers access these application programs. These companies often employ firewalls and security system to help ensure security. A firewall can help ensure that only certain types of messages are received by the company computers (i.e., servers) that provide these application programs. The firewall can discard all illegitimate messages before they are received by the servers, which helps to reduce the chances of a hacker breaking into the web site. A downside of using a firewall is that the extra processing performed by the firewall tends to increase the overall response time needed to respond to the messages. These companies also use security systems to aid in the approval of access to the application programs and the customer data.

When such applications program are made available to customers, it is often necessary for the employees of the company to have access to the application programs. Such employees could access the application programs through the Internet in the same way that their customers access the application programs. Because of the slow response time associated with Internet access and because data transmitted through an external network (e.g., the Internet) is often less secure than data transmitted through the company's internal network, companies typically allow their employee to access such application programs directly through their internal network. To support such access, the companies may provide on separate servers for the application programs that are accessible through the external network and for the application programs that are accessible through the internal network. Each server would typically have access to its own security system. The use of two security system may be expensive both in terms of cost of the two systems and time needed to administer the two systems. It would be desirable to have a technique by which these expenses can be avoided.

### BRIEF DESCRIPTION OF THE DRAWING

FIG. 1 is a block diagram illustrating the components of the common network security system.

### DETAILED DESCRIPTION

A method and system for providing network security for Internet, intranet, and extranet networks using a common mechanism is provided. In general, because the security of the Internet, intranet, and extranet networks varies greatly, different security mechanisms have been implemented for each network. For example, because the Internet is generally considered to be insecure, a high level of security is applied to communications via the Internet or extranet (i.e., an external network) as described in the background. In contrast, because an intranet (i.e., an internal network) is generally considered to be secure, a much lower level of security is needed when communicating via an intranet. The common network security system provides a common security mechanism for use when communicating via the Internet, intranet, or extranet. The common network security system provides a security module that can be shared by a web server that services the external network and a web server that services the internal network. The Internet web server is shielded from the Internet via a site firewall and the security module is shielded from the Internet web server via a security firewall.

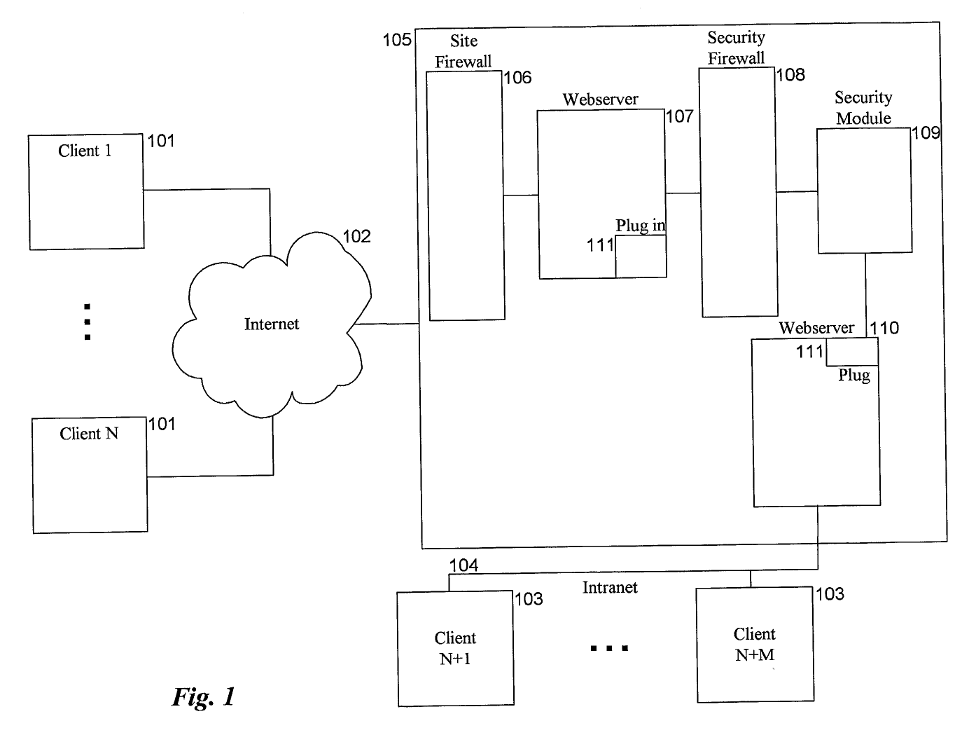

FIG. 1 is a block diagram illustrating the components of the common network security system. The Internet clients 101 are connected via the Internet 102 to the web site 105. Similarly, the intranet clients 103 are connected via intranet 104 to the web site 105. Web site 105 includes a site firewall 106, an Internet web server 107, a security firewall 108, a security module 109, and an intranet web server 110. The computers may include a central processing unit, memory, input devices (e.g., keyboard and pointing devices), output devices (e.g., display devices), and storage devices (e.g., disk drives). The memory and storage devices are computer-readable media that may contain instructions that implement the software of the security system. In addition, data structures and message structures may be stored or transmitted via a data transmission medium, such as a signal on a communications link.

The site firewall ensures that only certain types of Internet communications will be accepted by the site. For example, the site firewall may ensure that only HTTP (i.e., Port 80) or HTTPs (i.e., Port 443) messages will be accepted. The Internet web server and the intranet web server may contain identical web pages and server software. These web servers may include a security plug in component 111 for communicating with the security module. The Internet web server is connected to the security module through the security firewall. The security firewall accepts only communications to certain IP addresses and port numbers. In particular, the security firewall only allows communications to the IP address and port numbers associated with the security module. These IP addresses and port numbers are referred to as security “pin holes.” The security module (e.g., Netegrity's SiteMinder) may provide both authentication and authorization services. Authentication refers to the process of ensuring that a user really is the person that the user claims to be. The authentication process may use passwords or digital signatures. Authorization refers to the process of ensuring that the user is authorized to use a requested resource. For example, the authorization process may ensure that a user is authorized to use the requested application program. The intranet web server is connected directly to the security module. Whenever the internet or intranet web server needs to apply security, the web servers invoke their plug in components. The plug in component interacts with the security module.

This common network security organization allows a single security module to contain security information for both secure (e.g., intranet) and insecure (e.g., Internet) networks. The use of the common security module facilitates the maintaining of authentication and authorization information. For example, a user that uses both the Internet and an intranet to access a web site need only have their authorization and authentication information maintained in one location. Also, because intranet communications do not pass through any firewall, the associated overhead is avoided.

Although specific embodiments have been described, it is not intended that the invention be limited to these embodiments. One skilled in the art will appreciate that various modifications can be made without deviating from the spirit of the invention. For example, the architecture of the security system can be used in any client/server type environment and need not be limited to use with web servers. Also, the security system can be used to control access to resources other than web pages. For example, the other resources may include application programs, databases, and so on. The invention is defined by the claims that follow.

1. A security system for controlling access to a web site from an external network and an internal network, comprising:
a security module executing on a security system, the security module for controlling access to web pages;
a external web server for servicing requests for web pages from the external network;
a site firewall for receiving requests for web pages from the external network and for forwarding legitimate requests for web pages to the external web server;
a security firewall for receiving security requests from the external web server and for forwarding legitimate security requests to the security module, the security requests relating to access of a web page; and
an internal web server for servicing requests for web pages from the internal network and for forwarding the requests to the security module without passing the requests through the security firewall;
whereby requests to access web pages that are received from the external network and the internal network are authorized by the same security module.

2. The security system of claim 1 wherein a legitimate request for a web page is an HTTP request.

3. The security system of claim 1 wherein a legitimate request for a web page is an HTTPs request.

4. The security system of claim 1 wherein the external network is the Internet.

5. The security system of claim 1 wherein the external and internal web servers include a module for interfacing to the security module.

6. The security system of claim 1 wherein the external and internal web servers implement the same web pages.

7. The security system of claim 1 wherein the security module provides authentication services.

8. The security system of claim 1 wherein the security module provides authorization services.

9. The security system of claim 1 wherein a legitimate security request is received by the security firewall through a designated IP address and port number.

10. A method in a computer system for approving access to resources provided by a server, the method comprising:
receiving requests to access resources, the requests being received from an external network and an internal network;
requesting a security module to approve each request to access a resource irrespective of whether the request was received from the external network or the internal network;
when access to the resource is approved, granting access to the requested resource
whereby requests to access resource received from either the external network or the internal network are processed by the same security module.

11. The method of claim 10 wherein the requests received from the external network are passed through a site firewall before being processed by the server and security requests generated by the server are passed through a security firewall before being processed by the security module.

12. The method of claim 11 wherein the requests received from the internal network are not passed through a site firewall or security firewall.

13. The method of claim 12 wherein the requests received from the external network and requests received from the internal network are processed by different servers.

14. The method of claim 13 wherein the servers are web servers.

15. The method of claim 10 wherein the server is a web server.

16. The method of claim 10 wherein the resources are web pages.

17. The method of claim 10 wherein the external network is the Internet.

18. The method of claim 10 wherein the security module provides authentication services.

19. The method of claim 10 wherein the security module provides authorization services.

20. A security system for controlling access to resources, comprising:
a security module for approving access to the resources;
a server for servicing requests for resources;
a site firewall for receiving requests for resources and for forwarding legitimate requests for resources to the server; and
a security firewall for receiving security requests from the server and for forwarding legitimate security requests to the security module, the security requests relating to approving access to a resource.

21. The security system of claim 20 wherein the requests for resources are received from the Internet.

22. The security system of claim 20 wherein a legitimate request for a resource is an HTTP request.

23. The security system of claim 20 wherein a legitimate request for a resource is an HTTPs request.

24. The security system of claim 20 wherein the requests are received from an external network and wherein requests that are received from an internal network are process by a different server using the same security module, but without using the site firewall or security firewall.

25. The security system of claim 20 wherein resources are web pages.

26. The security system of claim 20 wherein the security module provides authentication services.

27. The security system of claim 20 wherein the security module provides authorization services.

28. The security system of claim 20 wherein a legitimate security request is received by the security firewall through a designated IP address and port number.

29. A method for configuring computer systems comprising:
connecting an external network to a site firewall, the site firewall for receiving requests for web pages from the external network and for forwarding legitimate requests through the site firewall;
connecting a external web server to the site firewall, the external web server for servicing legitimate requests for web pages received from the external network;
connecting a security firewall to the external web server, the security firewall for receiving security requests from the external web server and for forwarding legitimate security requests;
connecting a security module to the security firewall, the security module for receiving legitimate security requests and for approving legitimate security requests;
connecting an internal network to an internal web server, the internal web server for servicing requests for web pages received from the internal network; and
connecting the security module to the internal web server for receiving security requests and for approving the security requests
whereby requests to access web pages that are received from the external network and the internal network are approved by the same security module.

30. The method of claim 29 wherein a legitimate request for a web page is an HTTP request.

31. The method of claim 29 wherein a legitimate request for a web page is an HTTPs request.

32. The method of claim 29 wherein the external network is the Internet.

33. The method of claim 29 wherein the external and internal web servers include a module for interfacing to the security module.

34. The method of claim 29 wherein the external and internal web servers implement the same web pages.

35. The method of claim 29 wherein the security module provides authentication services.

36. The method of claim 29 wherein the security module provides authorization services.

37. The method of claim 29 wherein a legitimate security request is received by the security firewall through a designated IP address and port number.
